(19) United States
(12) Patent Application Publication
(10) Pub. No.: US 2025/0234817 A1
(43) Pub. Date: Jul. 24, 2025

(54) MUSHROOM HANDLING AND PACKING APPARATUS

(71) Applicant: Axis Technology and Development Limited, Gilford, County Down (GB)

(72) Inventors: Darryl Morrison, Gilford, County Down (GB); George Ivan Doake, Gilford, County Down (GB)

(21) Appl. No.: 18/703,353

(22) PCT Filed: Oct. 18, 2022
(86) PCT No.: PCT/EP2022/078968

§ 371 Date: Apr. 21, 2024

(30) Foreign Application Priority Data
Oct. 21, 2021 (GB) 2115111.3

(51) Int. Cl. A01G 18/62; B65B 25/04; B65B 35/24

(52) U.S. Cl. CPC A01G 18/62; B65B 25/046; B65B 35/24; B65G 2201/0211

(57) ABSTRACT

A mushroom handling apparatus is provided for handling and packing mushrooms grown in a plurality of vertically spaced mushroom growing beds arranged on trays in vertically tiered relationship on shelving The apparatus includes a frame, a mushroom transfer device mounted on the frame and incorporating a guide adapted to extend circumferentially around the mushroom growing beds, a plurality of mushroom holders mounted on the guide at spaced locations therealong, a drive associated with the guide for moving the mushroom holders to transfer mushrooms carried thereon between the mushroom growing beds and a mushroom packing device at one end of the frame, the mushroom packing device including a box support and means for automatically delivering mushrooms from the mushroom holders of the mushroom transfer device into a box located on the box support.

### CROSS REFERENCE TO RELATED APPLICATIONS

This present application is a § 371 National stage of International Application PCT/EP2022/078968, filed Oct. 18, 2022, which claims priority benefit of U.K. Pat. Application Ser. No. 2115111.3, filed Oct. 21, 2021, both of which are hereby incorporated herein by reference in their entireties.

### FIELD

The present invention relates to a mushroom handling apparatus for use in the handling and packing of mushrooms.

### BACKGROUND

It is a well established practice in the trade of mushroom growing to provide custom built growing houses in which the mushrooms may be grown in a carefully maintained environment. Mushrooms are usually commercially cultivated in a growing medium provided in trays, typically arranged in vertically tiered relationship on suitable shelving, the trays being located within a growing house which serves to shut out sunlight and provide a controlled environment, in terms of temperature and humidity conditions. Each tray or tier of trays defines a growing bed containing compost, on which the mushrooms are grown. Rows of shelving each having vertically tiered trays are usually separated by passages running therebetween.

Therefore, when harvesting the mushrooms, pickers travel along the passages between the rows of shelving, manually picking the mushrooms from the growing beds and depositing them in a basket or similar punnet or onto a conveyor for subsequent transfer to a separate location for manual packing into boxes or punnets. This is a very labour intensive and relatively slow process.

### SUMMARY

Embodiments of the present invention provide a mushroom handling apparatus which is capable of receiving hand-picked mushrooms and transporting them from a growing bed to a processing station, such as a packaging station, in particular for bulk packing in boxes, without interruption of the picking process and with minimal manual intervention. Optionally, a mushroom packing apparatus automatically delivers loose mushrooms into boxes or punnets without manual intervention.

According to one form of the present invention there is provided a mushroom handling apparatus for handling and packing mushrooms grown in mushroom growing beds arranged on trays, the apparatus comprising a frame, a mushroom transfer device being mounted on the frame and incorporating a guide means adapted to extend circumferentially around the mushroom growing beds, a plurality of mushroom holders being mounted on the guide means at spaced locations therealong, drive means being associated with the guide means for moving the mushroom holders to transfer mushrooms carried thereon between the mushroom growing beds and a mushroom packing device at one end of the frame, the mushroom packing device including a box support and means for automatically delivering mushrooms from the mushroom holders of the mushroom transfer device into a box located on the box support.

Optionally, a portion of the guide means of the mushroom transfer device carrying the mushroom holders passes over the box support of the mushroom packing device, the mushroom packing device incorporating a pusher device being provided and having a least a portion thereof adapted to intersect the path of the guide means such that the pusher device engages the heads of mushrooms held in the mushroom holders to displace mushrooms out of the mushroom holders to fall into a box located on the box support. The pusher device may comprise an endless flexible member extending between guide pulleys or sprockets and driven by a drive means such that a portion of the endless flexible member, arranged to intersect the path of the guide means of the mushroom transfer device, travels at the same speed and direction as the mushroom holders to engage mushrooms carried on the mushroom holders and push the mushrooms out of the mushroom holders to fall into a box on the box support. The guide pulleys or sprockets may be arranged on either side of the path of the guide means such that the endless flexible member traverses the path of the guide means at an acute angle to the guide means. One or both of the guide pulleys or sprockets may be mounted to be laterally displaced with respect to the guide means to vary the point of intersection of the pusher device with the path of the guide means to spread the mushrooms evenly into the box on the box support.

The box support may be adapted to cyclically displace the box laterally and/or longitudinally as it is filled with mushrooms to spread the mushrooms evenly into the box.

In one embodiment the box support may comprise a belt conveyor. Alternatively the box support may comprise a table or roller conveyor.

Optionally, the box support is provided with a load cell for determining when a box has been filled with mushrooms, the box support being or an associated pusher adapted to move a box onto a transfer region when it is determined that a box is full.

At least a portion of the transfer region comprises a downwardly inclined roller conveyor. The transfer region may include a pusher adapted to push filled boxes laterally into two or more rows on the transfer region. The transfer region may be adapted to feed filled boxes onto a conveyor.

The packing device may further comprise a magazine for storing a supply of empty boxes and incorporating a controller for automatically supplying boxes from the magazine onto the box support for filling with mushrooms. The magazine may be located above the box support. Optionally, the magazine is adapted to store a plurality of empty boxes and the controller is programed to sequentially supply empty boxes onto the box support for filling.

In one embodiment the magazine may incorporate a folding device for folding cardboard blanks into boxes under the control of the magazine controller and sequentially supplying folded boxes onto the box support to be filled, the magazine including a storage region for storing cardboard blanks prior to folding

In one embodiment the mushroom growing beds may be arranged on trays in vertically tiered relationship on shelving, a lifting means being provided, adapted to adjust the height of the frame with respect to the shelving to bring the mushroom transfer device and mushroom packing device into vertical alignment with selected vertically tiered growing beds. Alternatively the mushroom growing beds may all be arranged at the same level.

Cutting means may be provided for cutting off the stem of mushrooms as they are carried by the mushroom holders of the mushroom transfer device. The cutting means may be located adjacent the mushroom packing device.

In another embodiment each mushroom holder of the mushroom transfer device comprises a base portion and a pair of spaced apart fingers extending outwardly from the base portion to be located on either side of the stem of a mushroom such that the cap of the mushroom is supported upon the fingers. The pusher device of the mushroom packing device may be adapted to engage the heads of mushrooms carried on the mushroom holders to laterally displace the mushrooms away from the base portion of the respective mushroom holder as the mushroom holders pass over the box support.

The guide means of the mushroom transfer device may comprise an endless flexible member extending between guide members.

According to a further aspect of the present invention there is provided a mushroom growing assembly comprising shelving defining a plurality of vertically spaced mushroom growing beds arranged in vertically tiered relationship and a mushroom handling apparatus in accordance with the first aspect of the invention mounted on the shelving.

These and other objects, advantages, purposes and features of the present invention will become apparent upon review of the following specification in conjunction with the drawings.

### BRIEF DESCRIPTION OF THE DRAWINGS

A mushroom handling and packing apparatus in accordance with an embodiment of the present invention will now be described, by way of example only, with reference to the accompanying drawings, in which;

FIGS. 1 to 3 are perspective views of a mushroom handling and packing apparatus in accordance with an embodiment of the present invention;

FIG. 4 is a detailed perspective view of a mushroom transfer unit of the apparatus of FIGS. 1 to 3;

FIGS. 5 to 8 are perspective views of a packing unit of the apparatus of FIGS. 1 to 3;

FIG. 9 is a side view of the packing unit of FIGS. 5 to 8;

FIGS. 10 and 11 are detailed perspective views of the packing unit of FIGS. 5 to 8;

FIG. 12 is a detailed view showing the transfer of mushrooms into a box in the packing unit of FIGS. 5 to 8; and

FIG. 13 is a detailed view showing the box handling mechanism of the packing unit of FIGS. 5 to 8.

### DETAILED DESCRIPTION OF THE DRAWINGS

Referring now to the accompanying drawings, there is illustrated a mushroom handling and packing apparatus for expediting the picking and packing of mushrooms 1 grown on tiered growing beds supported on vertically tiered trays provided on shelving 2, the apparatus comprising a mushroom transfer unit 10 for conveying mushroom from the growing beds to a mushroom packing unit 20 wherein the mushrooms are automatically delivered into boxes or punnets. It is also envisaged that a mushroom handling and packing apparatus may be used for the picking and packing of mushrooms grown on growing beds arranged at a single level.

The mushroom transfer unit 10 and mushroom packing unit 20 are mounted on a common support frame 30 supported on the shelving 2. The mushroom transfer unit 10 is mounted on the support frame 30 to extend around the growing beds for conveying mushrooms 1 between the growing beds and the mushroom packing unit 20 is mounted on one end of the support frame 30.

The support frame 30 is supported on the shelving 2 via a lifting mechanism adapted to raise and lower the support frame 30 with respect to the shelving 2 to bring the mushroom transfer unit 10 and packing unit 20 level with a selected tier of the mushroom growing beds 4.

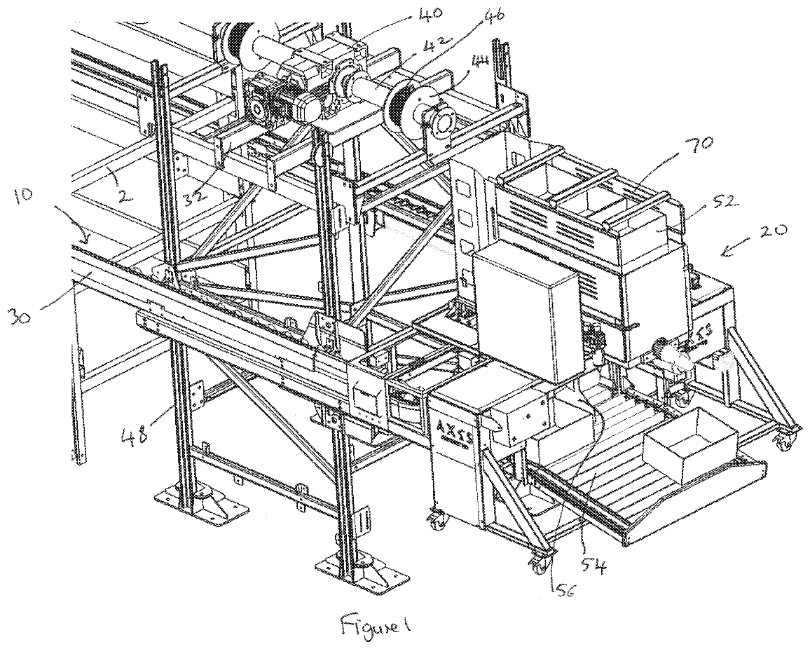

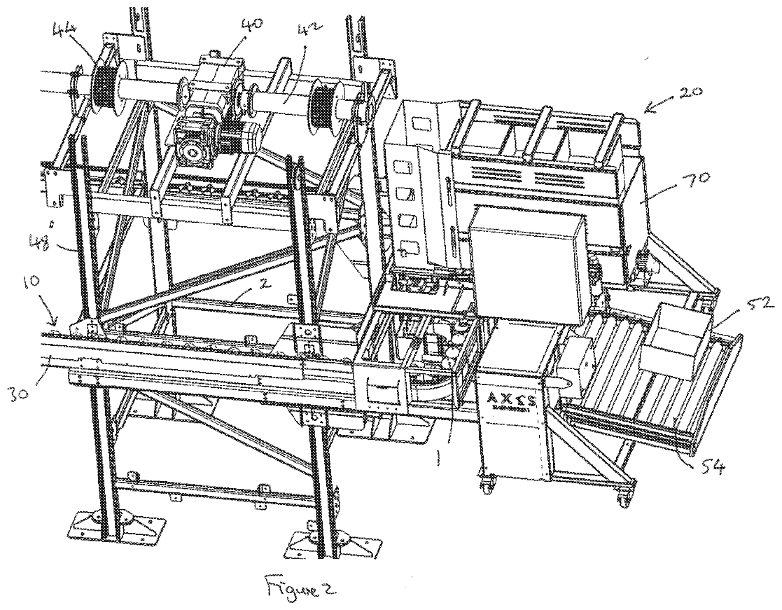

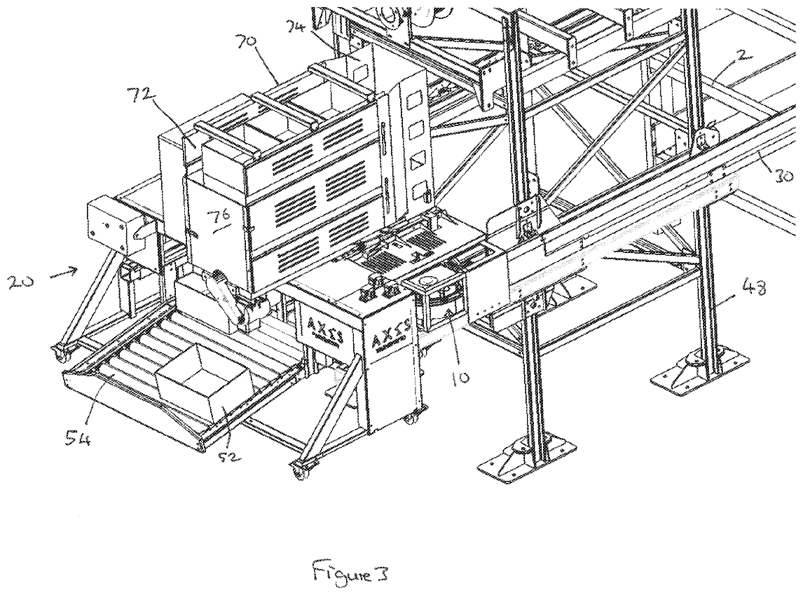

In the embodiment shown, the lifting mechanism comprises a winch assembly 40 mounted on the top of a lifting frame 32 provided adjacent one end of the shelving 2, as illustrated in FIG. 1. The winch assembly 40 may comprise a common motor driven shaft 42 extending along the top of the shelving 2 parallel to a longitudinal axis of the shelving, axially spaced lifting pulleys 44 being mounted upon the shaft 42 and upon which are wound lifting cables 46 coupled to the support frame 30 at spaced locations therealong. As the shaft 42 of the winch assembly 40 rotates, under the action of a drive motor, the lifting cables 46 wrap around the lifting pulleys 44 mounted on the shaft 42, and thereby adjust the height of the support frame 30, and the mushroom transfer unit 10 and mushroom packing unit 20 mounted thereon, with respect to the tiered growing beds on the shelving 2.

The support frame 30 may be coupled to a plurality of upright guide channels 48 provided on the shelving 2 and the adjacent lifting frame 32, within which mounting portions of the support frame 30 are slideably guided to guide vertical movement of the support frame 30 with respect to the shelving 2. The height of the support frame 30 with respect to the growing beds 4 on the shelving 2 may be controlled by limit switches adjacent each tier of the shelving 2 and at the top and bottom of the shelving. The mushroom packing unit 20 is mounted on one end of the support frame 30 via the two laterally extending ‘lifting forks’. Park position switches may be provided to define a park position of the support frame 30, optionally at its uppermost position on the shelving 2, which position may be used when the mushroom handling apparatus is inactive to facilitate access to the growing beds 4.

The mushroom transfer unit 10 may include an endless drive chain 12 mounted on guide sprockets to extend around the periphery of the support frame 30 and thereby around the tiers of mushroom growing beds 4. A plurality of spaced apart mushroom holders 16 are mounted on the chain 12, each mushroom holder 16 comprising a base portion and pair of spaced apart fingers extending substantially horizontally and outwardly from the base portion to be located on either side of the stem of a mushroom 1, such that the cap of the mushroom can be supported upon the fingers of each holder 16.

With the support frame 30 brought into vertical alignment with a selected tier of the vertically stacked mushroom growing beds on the shelving 2, the mushrooms 1 are picked and placed onto individual mushroom holders 16 of the mushroom transfer unit 10 as the holders 16 move past the mushroom growing bed, each mushroom 1 being placed onto a respective holder 16 with the stalk located between the fingers and the cap supported on top of the fingers. The fingers of each mushroom holder 16 may diverge outwardly from one another to facilitate location of a mushroom into a respective holder 16. Optionally, the mushroom holders 16 are arranged on the chain 12 of the mushroom transfer unit 10 such that the fingers face towards the adjacent growing bed.

An operator platform (not shown) may be provided on the support frame, adjacent at least a loading region of the mushroom transfer device, for example extending around three sides of the selected growing bed, such that the height of the operator platform can be adjustable by raising and lowering the support frame 30 with respect to the shelving 2 and so that the operator platform may be maintained in alignment with the mushroom transfer unit 10. Alternatively the operator platform may be moved independently of the support frame 30.

The mushrooms 1, carried by the mushroom holders 16 of the mushroom transfer unit 10, proceed to the mushroom packing unit 20 at one end of the support frame 30, whereat mushrooms are automatically displaced from the holders 16 and delivered into boxes, as will be described below in more detail.

The mushroom packing unit 20 comprises a pusher device in the form of an endless pusher band 22, which may include a polyurethane belt, guided around pulleys 24,26 and driven by a motor such that a least a portion of the pusher band 22 (specifically one side of the loop defined by the band) is adapted to intersect the path of travel of the mushroom holders 16 mounted on the drive chain 12 of the transfer unit 10 such that the pusher band 22 engages the heads of mushrooms held in the mushroom holders 16 to displace mushrooms out of the mushroom holders 16, away from the base portion of the respective holder 16, to push the mushrooms off the fingers of the mushroom holders 16 to fall into a box located therebelow.

The guide pulleys 24,26 of the pusher band 22 of the packing unit 20 are arranged on either side of the path of travel of the mushroom holders 16 of the transfer unit 10 such that the pusher band 22 traverses the travel path at an acute angle to thereto, downstream of the direction of movement of the mushroom holders 16.

The pusher band 22 of the packing unit 20 may be driven at the same speed and direction as the drive chain 12 of the mushroom holders 16 of the transfer unit 10 such that the pusher band 22 engages the heads of the mushrooms 1 carried by the mushroom holders 16 at substantially the same speed and direction as the mushrooms are travelling, avoiding sliding contact between the mushrooms and the pusher band 22 which might otherwise damage the mushrooms.

The packing unit 20 includes a weigh conveyor 50 or box support in the form of a belt conveyor located beneath the pusher device and upon which a box 52 may be supported to be filled. A load cell or similar load measuring device (not shown) is optionally located beneath the upper run of the weigh conveyor 50 to determine the weight of the box and contents located thereon. The load cell is coupled to a controller for determining when a box has been filled with mushrooms. The controller may be programmed to operate the weigh conveyor to move a box onto an adjacent transfer region 54, such as in the form of a roller conveyor, when it is determined that a box is full, whereupon filled boxes may be stored before being removed to a storage location. The rollers of the transfer region 54 may be driven. At least a portion of the transfer region may slope downwardly away from the weigh conveyor 50. The transfer region 54 may be adapted to deliver filled boxes onto a conveyor or onto a holding area from where an operator may manually remove filled boxes. The transfer region 54 may be provided with a laterally extending pusher 56 to laterally move the filled boxes into two or more rows on the transfer region.

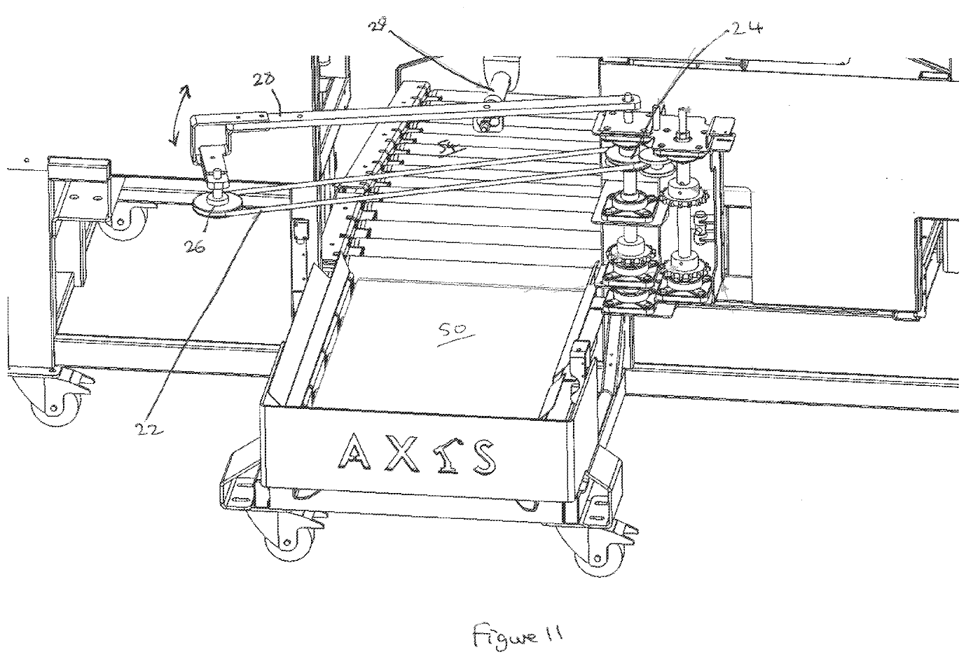

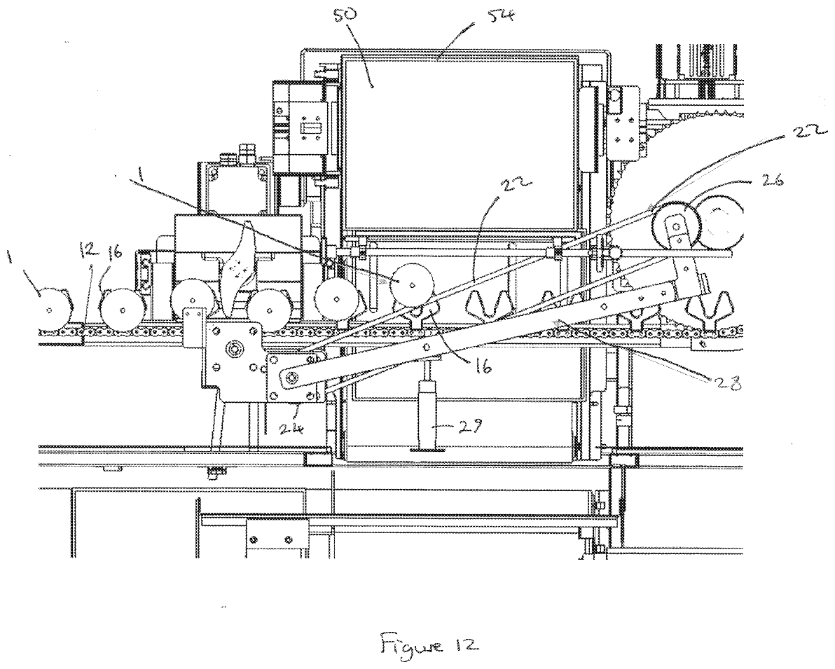

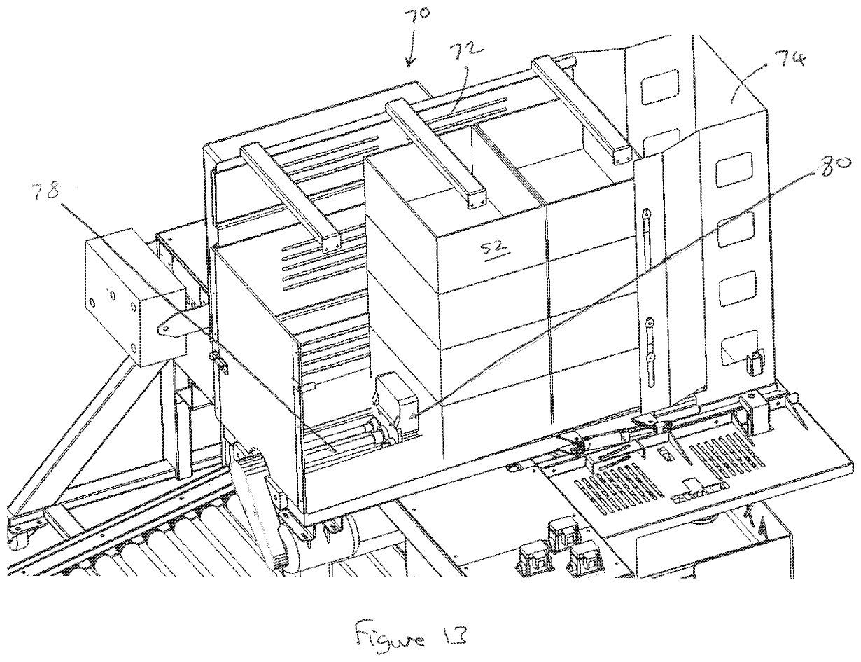

The weigh conveyor 50 may also be adapted to cyclically displace a box laterally and/or longitudinally as it is filled with mushrooms to spread the mushrooms evenly into the box. One or both of the guide pulleys 24,26 of the pusher band 22, such as a downstream pulley 26, may be mounted on a movable bar adapted to be laterally displaced with respect to the drive chain 12 of the transfer unit 10 to vary the point of intersection of the pusher band 22 of the packing unit 20 with the travel path of the mushroom holders 16 to further spread the mushrooms evenly into the box on the weigh conveyor 50. For example and as shown in FIGS. 11 and 12, the downstream or distal pulley 26 of the pusher band 22 may be mounted on a pivotally mounted cantilevered arm 28 driven by an actuator 29 for reciprocating lateral movement.

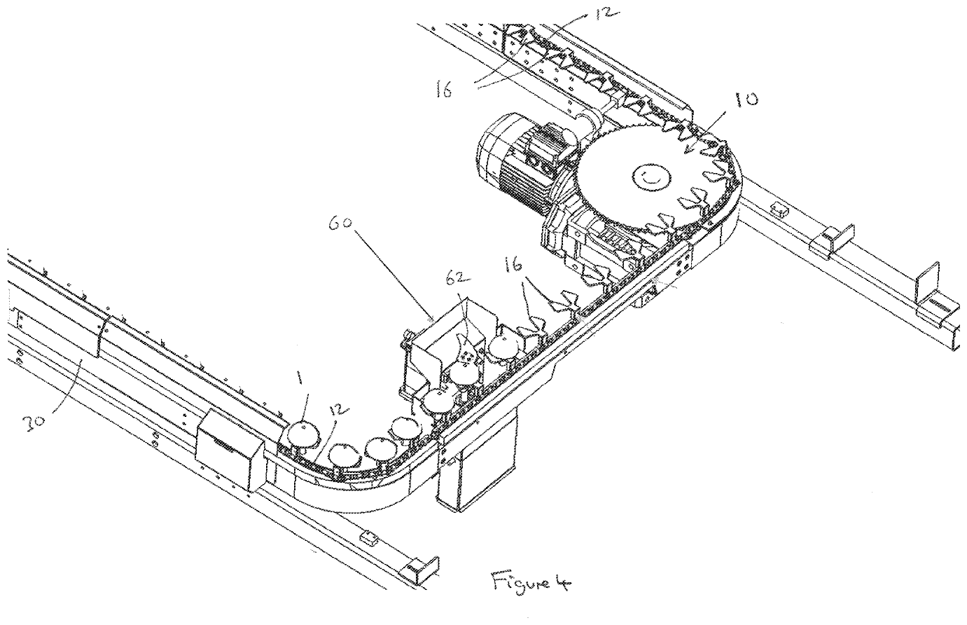

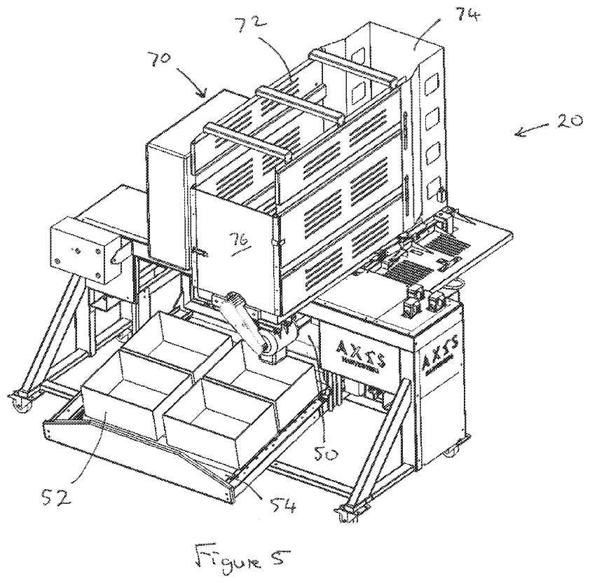

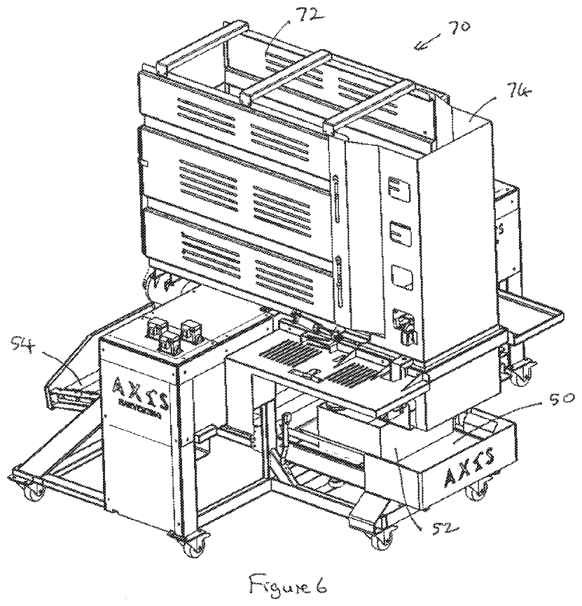

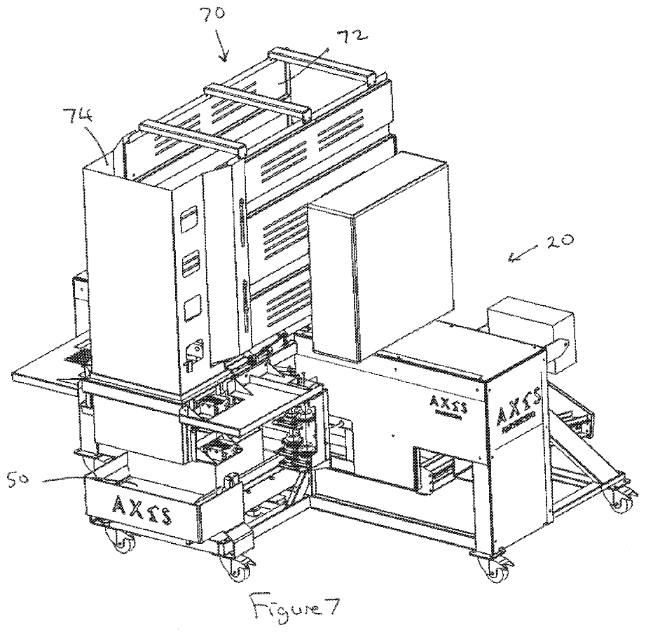

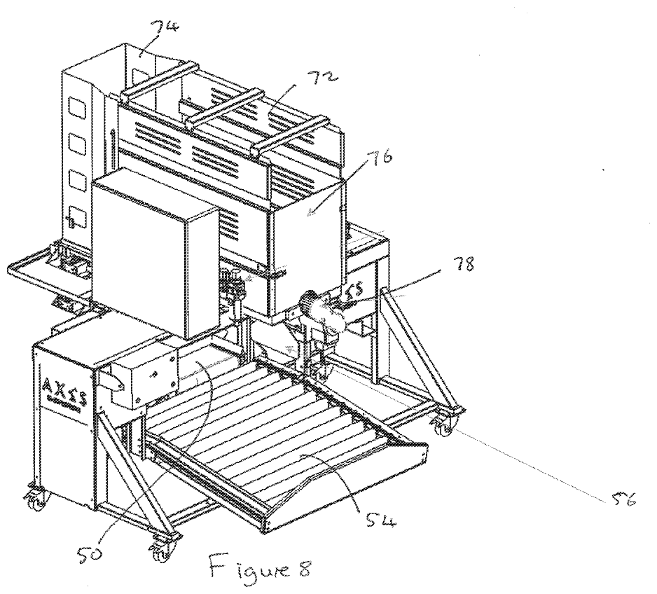

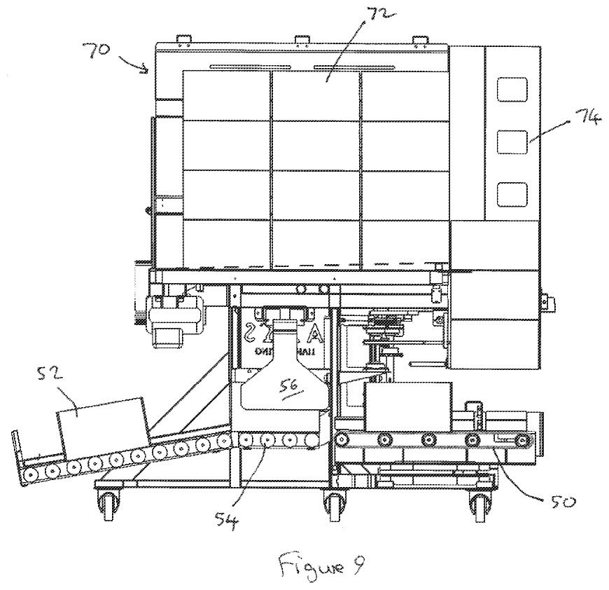

As illustrated in FIG. 4, a cutting system 60 may be provided for cutting the stalks of the mushrooms 1 as they are conveyed on the mushroom holders 16 of the mushroom transfer unit 10. The cutting system 60 may be located so as to remove the stalks as the mushrooms enter the packing unit 20 before being delivered into boxes on the weigh conveyor 50. In the embodiment shown in the drawings, the cutting system 60 may comprise a rotary blade 62 driven at high speed, for example up to 10,000 rpm, the 62 blade extending into the path of and below the mushroom holders 16 to cut the stalks as the mushrooms are conveyed on the holders 16 past the cutting system 60. The blade 62 may be adjustable vertically with respect to the mushroom holders 16 to adjust the length at which the stalks are cut. The blade may be rotated by a stepper or servo motor which rotates the blade only when it is required to cut the stalk of a mushroom, the rotation of the blade being configured to be synchronised with the movement of the mushroom holders 16 on the mushroom transfer unit 10. The blades may be rotated through less than 360°, for example through 270° or 180°.

The packing unit 20 also includes a box magazine 70 for holding a plurality of empty boxes, the magazine 70 being adapted to automatically supply boxes onto the weigh conveyor 50 for filling with mushrooms. The box magazine 70 is located over the weigh conveyor 50.

The box magazine 70 includes a storage region 72 for holding rows of stacked empty boxes and a delivery chute 74 at one end of the storage region 72, the delivery chute 74 being located above the weigh conveyor and having an opening at a lower end for dropping boxes onto the weigh conveyor 50.

An access door 76 may be provided at one end of the storage region 72 to allow the box magazine 70 to be refilled. The door 76 may be transparent, provided with windows and/or formed from a mesh to allow the boxes within the magazine to be seen.

A lead screw 78 may be provided for laterally driving a box pusher 80 for urging stacks of boxes from the storage region 72 into the delivery chute 74 and upper grippers or guides may be associated with the delivery chute 74 and control flaps or lower grippers may be provided at a lower end of the delivery chute 74 for controlling the passage of individual empty boxes through the delivery chute 74 and onto the weigh conveyor 50.

The packing unit 20 may include three circuits of pneumatic cylinders for controlling operation of the box magazine 70.

One or more 1st cylinders operating box guides to allow a stack of boxes to be pushed into the delivery chute 74 by the box pusher 80 without toppling over.

One or more 2nd cylinders operating the upper grippers or guides to hold the second box in the stack of boxes in the delivery chute 74 to allow the bottom box to drop onto the weigh conveyor 50.

One or more 3rd cylinders operating the control flaps or lower grippers to hold the bottom box from dropping onto the weigh conveyor.

The box magazine 70 is adapted to store a plurality of empty boxes and a magazine controller is programmed to sequentially supply empty boxes onto the weigh conveyor for filling. In an alternative embodiment the box magazine may be adapted to store empty boxes in nested relationship and may be provided with means for de-nesting the boxes before delivering them onto the weigh conveyor 50.

In a further embodiment the box magazine 70 may incorporate a folding mechanism for folding cardboard blanks into boxes under the control of the magazine controller and sequentially supplying folded boxes onto the box support to be filled, the storage region being adapted to store one or more stacks of cardboard blanks prior to folding.

In a further embodiment the packing unit 20 may be adapted to deliver punnets to the box support for filling with mushrooms. The punnets may be stored, typically in nested relationship, in the magazine and fed onto the box support using a suitable feed arrangement.

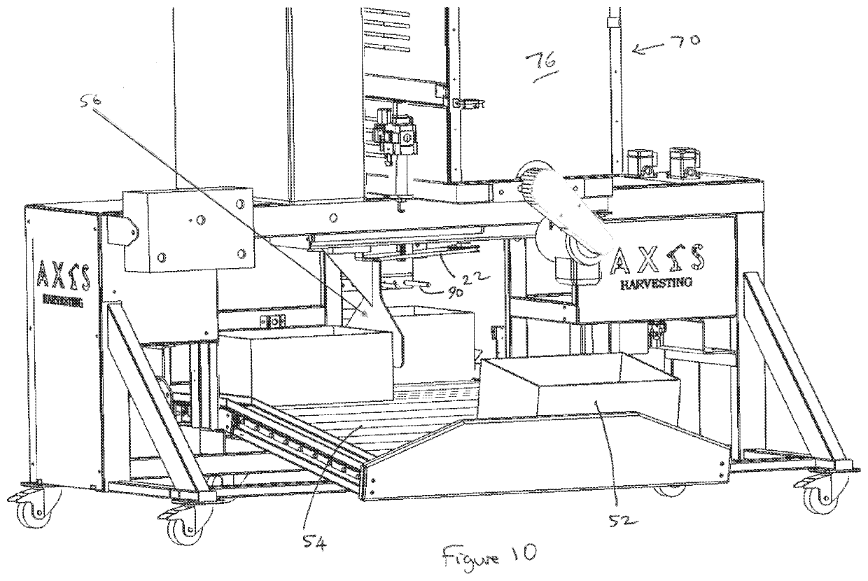

An adjustable deflection bar system may be provided whereby guide bars 90 (see FIG. 10) may be provided to help the spread of mushrooms into the box and slow the fall of the mushrooms as they fall from the mushroom holders 16 into the box 52 on the weigh conveyor 50.

The pusher band 22 of the packing unit 20 is adapted to push mushrooms 1 off the mushroom holders 16 of the transfer unit 10 at the same speed as the mushrooms are conveyed on the holders 16, which reduces friction that may damage the mushroom.

In use, an operator opens the access door 76 of the box magazine 70 and loads boxes into the magazine (for example 16 boxes 4 stacks of 4-10 lb or 28 boxes 4 stacks of 7-5 lb), ensuring box pusher 80 is in its retracted or home position. The access door 76 is then closed and secured and the apparatus is activated. The control flaps or lower grippers of the delivery chute 74 are closed and the lead screw 78 activates to move the box pusher 80, pushing the stacked boxes laterally along magazine 70 to push a row into the delivery chute 74 on top of the control flaps/upper grippers. Once the box pusher 80 has moved a distance equivalent to the width of the boxes it may reverse a short distance (for example 5 mm) to allow the stack of boxes displaced into the delivery chute 74 to become freed.

The upper grippers or guides of the delivery chute 74 will be activated to engage at least the second from lowest box in the stack in the delivery chute 74 and the control flaps or lower grippers of the delivery chute 74 may be retracted to drop the lowermost box in the delivery chute 74 onto the weigh conveyor 50.

The weigh conveyor 50 will be operated such that the box on the weigh conveyor 50 is moved forward to meet a home sensor and the drive chain 12 of the mushroom transfer unit 10 will be driven to move mushrooms 1 on the mushroom holders 16 along their travel path from the growing beds to the packing unit 20.

As the mushroom holders 16 pass the pusher band 22 they will be deflected off the mushroom holders 16 to fall into the box 52 on the weigh conveyor 50. The pusher band 22 and/or the weigh conveyor 50 may be cyclically moved as the box 52 is filled to spread the mushrooms evenly into the box to evenly fill the box. Once the box 52 and its contents has reached the required weight, as determined by the load cell of the weigh conveyor 50, the weigh conveyor 50 is operated to move the filled box onto the transfer region 54.

If filled boxes are already present in a first row on the transfer region 54, subsequent filled boxes will be pushed laterally to form a second row by activation of the transfer region pusher 56.

The sequence may continue until all boxes 52 in that stack are emptied from the delivery chute 74. The box pusher 80 will then be operated to move the next stack of empty boxes from the storage region 72 of the magazine 70 into the delivery chute 74 and the process continues.

Instead of a weigh conveyer, the box support may comprise a weigh table and full boxes or punnets may be displaced from the weigh table onto a transfer region by means of a suitable pusher device. The weigh table may be adapted to move laterally or longitudinally to facilitate even filling of a box or punnet located thereon.

The invention is not limited to the embodiment described herein but can be amended or modified without departing from the scope of the present invention which is intended to be limited only by the scope of the appended claims as interpreted according to the principles of patent law including the doctrine of equivalents.

1. A mushroom handling apparatus for handling and packing mushrooms grown in a plurality of mushroom growing beds arranged on trays, said apparatus comprising:
a frame;
a mushroom transfer device mounted on said frame and incorporating a guide adapted to extend circumferentially around the mushroom growing beds;
a plurality of mushroom holders mounted on said guide at spaced locations therealong;
a mushroom packing device at one end of said frame; and
a drive associated with said guide for moving said mushroom holders to transfer mushrooms carried thereon between the mushroom growing beds and said mushroom packing device;
said mushroom packing device including a box support and a mushroom deliverer for automatically delivering mushrooms from said mushroom holders of said mushroom transfer device into a box located on said box support.

2. The apparatus as claimed in claim 1, wherein a portion of said guide of said mushroom transfer device is configured to carry said mushroom holders over said box support of said mushroom packing device, said mushroom packing device incorporating a pusher device being provided and having a least a portion thereof adapted to intersect the path of said guide such that said pusher device engages the heads of mushrooms held in said mushroom holders to displace the mushrooms out of said mushroom holders to fall into the box located on said box support.

3. The apparatus as claimed in claim 2, wherein said pusher device comprises an endless flexible member extending between guide pulleys or sprockets and driven by a drive such that a portion of said endless flexible member, arranged to intersect the path of said guide of said mushroom transfer device, travels at the same speed and direction as said mushroom holders to engage mushrooms carried on said mushroom holders and push the mushrooms out of said mushroom holders to fall into the box on said box support.

4. The apparatus as claimed in claim 3, wherein said guide pulleys or sprockets are arranged on either side of the path of said guide such that said endless flexible member traverses the path of said guide at an acute angle to said guide.

5. The apparatus as claimed in claim 3, wherein one or both of said guide pulleys or sprockets are mounted to be laterally displaced with respect to said guide to vary the point of intersection of said pusher device with the path of said guide to spread the mushrooms evenly into the box on said box support.

6. The apparatus as claimed in claim 1, wherein said box support is adapted to cyclically displace the box laterally and/or longitudinally as it is filled with mushrooms to spread the mushrooms evenly into the box.

7. The apparatus as claimed in claim 1, wherein said box support comprises a belt conveyor, a roller conveyor or a fixed or moveable table.

8. The apparatus as claimed in claim 1, wherein said box support is provided with a load cell for determining when the box has been filled with mushrooms, said box support or an associated pusher being adapted to move the box onto a transfer region when it is determined that the box is full.

9. The apparatus as claimed in claim 8, wherein said apparatus comprises said transfer region, and wherein at least a portion of said transfer region comprises a downwardly inclined roller conveyor.

10. The apparatus as claimed in claim 9, wherein said transfer region includes a pusher adapted to push filled boxes laterally into two or more rows on said transfer region.

11. The apparatus as claimed in claim 9, wherein said transfer region is adapted to feed filled boxes onto a conveyor.

12. The apparatus as claimed in claim 1, wherein said packing device further comprises a magazine for storing a supply of empty boxes and incorporating a controller for automatically supplying the empty boxes from said magazine onto said box support for filling the empty boxes with mushrooms.

13. The apparatus as claimed in claim 12, wherein said magazine is located above said box support.

14. The apparatus as claimed in claim 12, wherein said magazine is adapted to store a plurality of the empty boxes and said controller is programmed to sequentially supply the empty boxes onto said box support for filling.

15. The apparatus as claimed in claim 12, wherein said magazine incorporates a folding device for forming the empty boxes by folding cardboard blanks under the control of said magazine controller and sequentially supplying the empty boxes onto said box support to be filled, said magazine including a storage region for storing the cardboard blanks prior to folding.

16. The apparatus as claimed in claim 1, wherein the mushroom growing beds are arranged on trays in vertically tiered relationship on shelving, said apparatus further comprising a lift adapted to adjust the height of said frame with respect to the shelving to bring said mushroom transfer device and mushroom packing device into vertical alignment with selected ones of said vertically tiered growing beds.

17. The apparatus as claimed in claim 1, further comprising a cutter for cutting off the stems of mushrooms as they are carried by said mushroom holders of said mushroom transfer device.

18. The apparatus as claimed in claim 17, wherein said cutter is located adjacent said mushroom packing device.

19. The apparatus as claimed in claim 1, wherein each said mushroom holder of said mushroom transfer device comprises a base portion and a pair of spaced apart fingers extending outwardly from said base portion to be located on either side of the stem of a mushroom such that the cap of the mushroom is supported upon said fingers.

20. The apparatus as claimed in claim 19, wherein a portion of said guide of said mushroom transfer device is configured to carry said mushroom holders over said box support of said mushroom packing device, said mushroom packing device incorporating a pusher being provided and having a least a portion thereof adapted to intersect the path of said guide such that said pusher engages the heads of mushrooms held in said mushroom holders to displace mushrooms out of said mushroom holders to fall into the box located on said box support, wherein said pusher device of said mushroom packing device is adapted to engage the heads of mushrooms carried on said mushroom holders to laterally displace the mushrooms away from said base portion of said respective mushroom holder as said mushroom holders pass over said box support.

21. The apparatus of claim 1, wherein said guide of said mushroom transfer device comprises an endless flexible member extending between guide members.

22. (canceled)
